(19) United States
(12) Patent Application Publication
(10) Pub. No.: US 2005/0034353 A1
(43) Pub. Date: Feb. 17, 2005

(54) Roller guide, fishing pole and methods of manufacture thereof

(76) Inventor: Stephen Gustlin, Santa Ana, CA (US)

Correspondence Address: MICHAEL WINFIELD GOLTRY, 340 EAST PALM LANE, SUITE 260, PHOENIX, AZ, 85004, US

(21) Appl. No.: 10/947,739

(22) Filed: Sep. 23, 2004

Related U.S. Application Data
(63) Continuation of application No. 10/341,627, filed on Jan. 14, 2003, now abandoned.

(51) Int. Cl. A01K 87/04

(52) U.S. Cl. 43/24

(57) ABSTRACT

A roller guide consists of an elongate integral body having a proximal end and an opposing rollered distal end. A stepped inwardly tapered rod end attachment bore extends into the elongate integral body from the proximal end toward the rollered distal end. The attachment bore consists of a series of counterbores extending into the elongate body from the proximal end toward the rollered distal end and each defines an inner diameter, in which the inner diameters of the counterbores decrease progressively from the proximal end toward the distal end. A fishing pole has a tip disposed in and adhesively secured to the attachment bore of the roller guide.

### FIELD OF THE INVENTION

This invention relates to fishing poles and to fishing pole roller guides and associated methods of manufacture.

### BACKGROUND OF THE INVENTION

The development of fishing tackle has a long history. A most significant development fishing tackle is that of the running line and the associated advent of the reel. It is believed that small wire rings were placed at the ends of the tips of fishing poles of long past and became the first generation tip or rod tops, to lead from the reels the running lines to the tips of the rods. Since the advent of the first generation tip guides, skilled artisans have devoted considerable effort toward developing improved running line tip guides and to those guides, which are now commonly referred to as roller guides. Although significant improvements have been made, existing tip guides and roller guides are difficult to construct, expensive and suffer from structural shortcomings that make them prone to becoming detached from the tips of fishing poles. Given these and other deficiencies in the art, the need for certain new and useful improvements is evident.

### SUMMARY OF THE INVENTION

The above problems and others are at least partially solved and the above purposes and others realized in new and improved embodiments of a roller guide, a fishing pole and associated methods of manufacture. In accordance with the principle of the invention, a preferred apparatus embodiment consists of a roller guide including an elongate body having opposing neck and rollered ends, and a stepped inwardly tapered rod end attachment bore formed into the neck end of the elongate body. In a particular embodiment, the rollered end is characterized by an attached roller having a groove defined by opposing inwardly angled annular upper surfaces that lead to opposing inwardly angled annular lower surfaces, in which the angles defined by the lower surfaces of the roller are steeper than the angles defined by the upper surfaces of the roller. The elongate body is preferably integrally formed, and the attachment bore consists of a series of counterbores extending into the neck end of the elongate body and each defining an inner diameter. The inner diameters of the counterbores decrease progressively into the neck end of the elongate body. In a particular embodiment, a fishing pole has a tip disposed in, and secured to the roller guide at, the attachment bore. Preferably, a curable adhesive disposed in the attachment bore secures the tip of the fishing pole to the elongate body at the attachment bore. The stepped character of the attachment bore is highly desirable, as it provides spaced-apart annular gaps between the tip and the attachment bore. Uncured adhesive disposed in the attachment bore collects at the gaps when the tip of the fishing pole is forcibly disposed into and through the attachment bore. After waiting for a period of time sufficient to allow the adhesive to cure, namely, a curing period, the cured adhesive formations at the gaps provide an exemplary and surprisingly strong and rugged attachment of the roller guide to the tip.

In accordance with the principle of the invention, a preferred method embodiment includes providing an elongate body having opposing neck and rollered ends, and forming a stepped inwardly tapered rod end attachment bore into the neck end of the elongate body. In a particular embodiment, the rollered end is characterized by an attached roller having a groove defined by opposing inwardly angled annular upper surfaces that lead to opposing inwardly angled annular lower surfaces, in which the angles defined by the lower surfaces of the roller are steeper than the angles defined by the upper surfaces of the roller. The elongate body is preferably integrally formed, and the attachment bore consists of a series of counterbores extending into the neck end of the elongate body. The counterbores each define an inner diameter. The inner diameters of the counterbores decrease progressively into the neck end of the elongate body. In one embodiment, the method further includes providing a fishing pole having a tip, disposing the tip of the fishing pole in the attachment bore, and securing the tip of the fishing pole to the elongate body at the attachment bore. In another embodiment, the method further includes providing a fishing pole having a tip, disposing a curable adhesive into the attachment bore, disposing the tip of the fishing pole in the attachment bore, in which spaced-apart annular gaps form between the tip and the stepped inwardly tapered rod end attachment bore and the curable adhesive disposes at the gaps, and waiting for the curable adhesive to at least partially cure at the gaps.

Consistent with the foregoing, the invention also contemplates associated apparatus and method embodiments.

### BRIEF DESCRIPTION OF THE DRAWINGS

Referring to the drawings:

FIG. 1 is an exploded perspective view a roller guide constructed and arranged in accordance with the principle of the invention, the roller guide consisting of an elongate body having a rollered end and an opposing neck end;

FIG. 2 is a perspective view of a fishing pole incorporating the roller guide of FIG. 1;

FIG. 3 is a front elevation of the roller guide of FIG. 1;

FIG. 4 is a side elevation of the roller guide of FIG. 1, the opposing side elevation being a substantial mirror image thereof;

FIG. 5 is a horizontal sectional view of a neck of the roller guide of FIG. 1 illustrating a stepped bore formed into the neck;

FIG. 6 is a view very similar to the view of FIG. 5 illustrating a tip of a fishing pole disposed in, and attached to the roller guide at, the stepped bore; and

FIG. 7 is a vertical sectional view of a roller for use with the roller guide of FIG. 1.

### DETAILED DESCRIPTION OF PREFERRED EMBODIMENTS

Turning now to the drawings, in which like reference characters indicate corresponding elements throughout the several views, attention is first directed to FIG. 1 in which is seen a roller guide embodying the principle of the invention generally indicated by the reference character 10 including an elongate body 11 having opposing ends or extremities 12,13. A neck 14 is disposed between ends 12,13. Although body 11 can be constructed as an assembly of two or more attached parts, it is preferably integral and fashioned by casting or machining from stainless steel, aluminum, or other similar material or combination of materials. Integral formation for body 11 provides body 11 with exemplary strength and resistance against cracking. End 12 is considered a forward, distal or business end of roller guide 10 and end 13 is considered a rearward, proximal or neck end of roller guide 10.

End 12 is bifurcated, defining opposing parallel parts or branches 20,21. A roller 22 is disposed between and rotated to branches 20,21. Roller 22 has opposing sides 22A,22B, and a central groove 65. Sides 22A,22B have outer annular extremities or flats 22A′22B′, which lead to groove 65. Like body 11, roller 22 is fashioned from stainless steel, aluminum, or other similar material or combination of materials, with stainless steel being preferred for its resilient and non-corrosive properties. Roller 22 is integrally fashioned, but it can be constructed of a plurality of attached parts, whether two or more, if desired. In the preferred embodiment presented in this specification, branches 20,21 are fashioned with opposing openings 20A,21A. A headed and internally threaded sleeve 23 extends through opening 20A and into a central bore 24 extending through roller 22. A headed and externally threaded element or screw 25 extends through opening 21A and into central bore 24 and also into the open end of sleeve 23 threadably securing it. Sleeve 23 and screw 25 are tightened and secured against branches 20,21 forming an axle, to which roller 22 is secured between branches 20,21. Roller 22 rotates over this axle and, more particularly, over sleeve 23. Other ways of rotating roller 22 to branches 20,21 can be used in accordance with the ordinary skill attributed to one having regard for the art. As a matter of disclosure, FIG. 3 is a front elevation of roller guide 10 and FIG. 4 is a side elevation of roller guide 10, the opposing side elevation being a substantial mirror image thereof. It is to be understood that side 22A of roller faces branch 20, and side 22B faces branch 21.

FIG. 5 is a horizontal sectional view of neck 14 illustrating a bore 30 of roller guide 10, which extends into neck 14 through end 13. Bore 30 is blind and has a predetermined length and is stepped and altogether tapers inwardly into neck 14 from end 13 to end 12 of body 11 defining a greater internal diameter at end 13 and a lesser internal diameter at end 12. Bore 30 is considered a stepped inwardly tapered rod end attachment bore, and is formed into neck 14 from end 13 preferably by way of machining or drilling. Other suitable ways of forming bore 30 can be used. As previously intimated, body 11 can be cast and bore 30 so formed in such a process.

In this specific embodiment, the inwardly tapered and stepped character of bore 30 is provided by a series of counterbores 30A,30B,30C extending into neck 14 through end 13. Each of counterbores 30A,30B,30C defines an internal diameter, and the internal diameters of counterbores 30A,30B,30C decrease progressively into neck 14 from end 13 to end 12 (end 12 not denoted in FIG. 5), in which the internal diameter of counterbore 30A is the largest of the internal diameters, the internal diameter of counterbore 30C is the smallest of the internal diameters, and the internal diameter of counterbore 30B is of a size that falls between the internal diameters of counterbores 30A and 30C. Although three counterbores are depicted, namely, counterbores 30A,30B,30C, less or more can be employed. Three counterbores are depicted as a matter of illustration.

Roller guide 10 is for use with fishing poles that employ a running line, which characterizes modern fly-fishing and spinning rods. It is well understood among skilled artisans that guiding under reduced friction the fishing line from the reel to the tip is important, and that a roller guide at the tip of the fishing pole is essential for reducing line-to-pole friction for facilitating efficient casting and take-up of line.

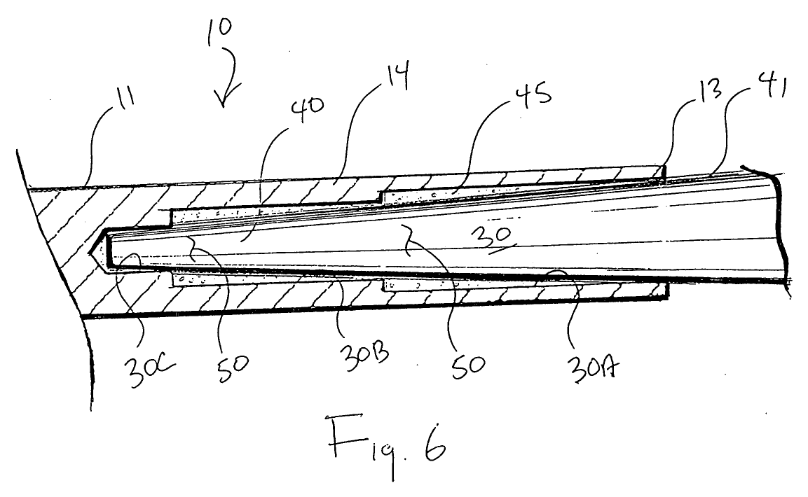

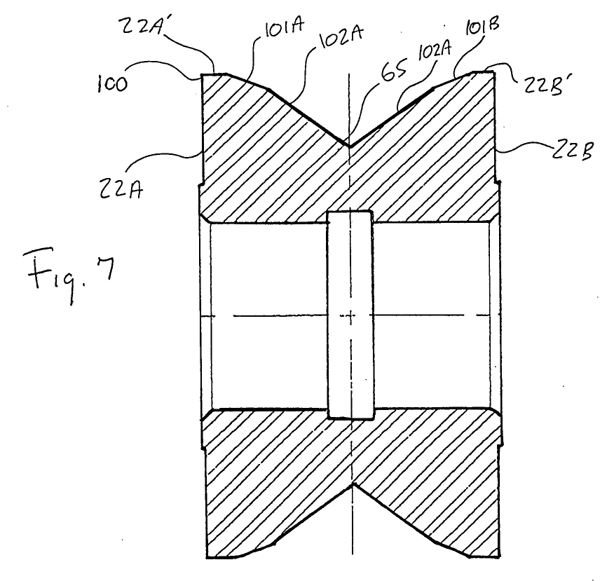

FIG. 6 is illustrative of the attachment of roller guide 10 to a tip or end 40 of a fishing pole 41. It is to be noted that the length of tip 40 extending into bore 30 through end 13 as denoted in FIG. 6 has a taper and external tapering diameter that is, although somewhat smaller, generally commensurate with the taper and internal tapering diameter provided for by counterbores 30A,30B,30C. In attaching tip 40 to roller guide 10, a curable adhesive 45, such as a silicon-based adhesive or other suitable, rugged and moisture-resistant curable adhesive commonly used to adhesively secure roller guides, is first disposed in bore 30 coating its interior surfaces including, in particular, the interior surfaces of counterbores 30A,30B,30C. After the adhesive is so disposed into and throughout bore 30, tip 40 is forced into and through bore 30 from counterbore 30A to counterbore 30C as in FIG. 6. The commensurate taper and respective internal and external diameters of bore 30 and tip 40 of pole 41 provide tight or snug fit between the external surface of tip 40 and the internal surface of bore 30 and, more particularly, the internal surfaces of counterbores 30A,30B,30C. The stepped character of bore 30 is essential, as it provides spaced-apart annular gaps 50 between bore 30 and tip 40 of pole 41, one between counterbores 30A,30B proximate the junction at which they meet, and one between counterbores 30B,30C proximate the junction at which they meet, as illustrated, into which adhesive 45 collects or migrates when tip 40 is forcibly disposed into and through bore 30. Gaps 50 encircle tip 40 of pole 41. After waiting for a period of time sufficient to allow adhesive 45 to cure, namely, a curing period, the cured adhesive formations at gaps 50 provide an exemplary and surprisingly strong and rugged attachment of roller guide 10 to tip 40.

The size of the tips and the degree of taper of various brands of fishing rods vary, even between rods of the same size. The stepped character of bore 30 is advantageous because it better accommodates the various tip diameters and tapers between different rods. In another aspect, the stepped character of bore 30 helps to better accommodate irregularities along the tip of a rod, as well as any minor variations in the taper angle of the rod tip. The stepped character of bore 30 also improves rod tip alignment in bore 30, and actually ensures proper and recommended tip alignment between the rod tip and roller guide 10. The stepped design of bore 30 also provides more gluing surface area, providing a more resilient and rugged adhesive attachment to the rod tip and a resulting bond that is highly resistant to breaking under extreme stress conditions.

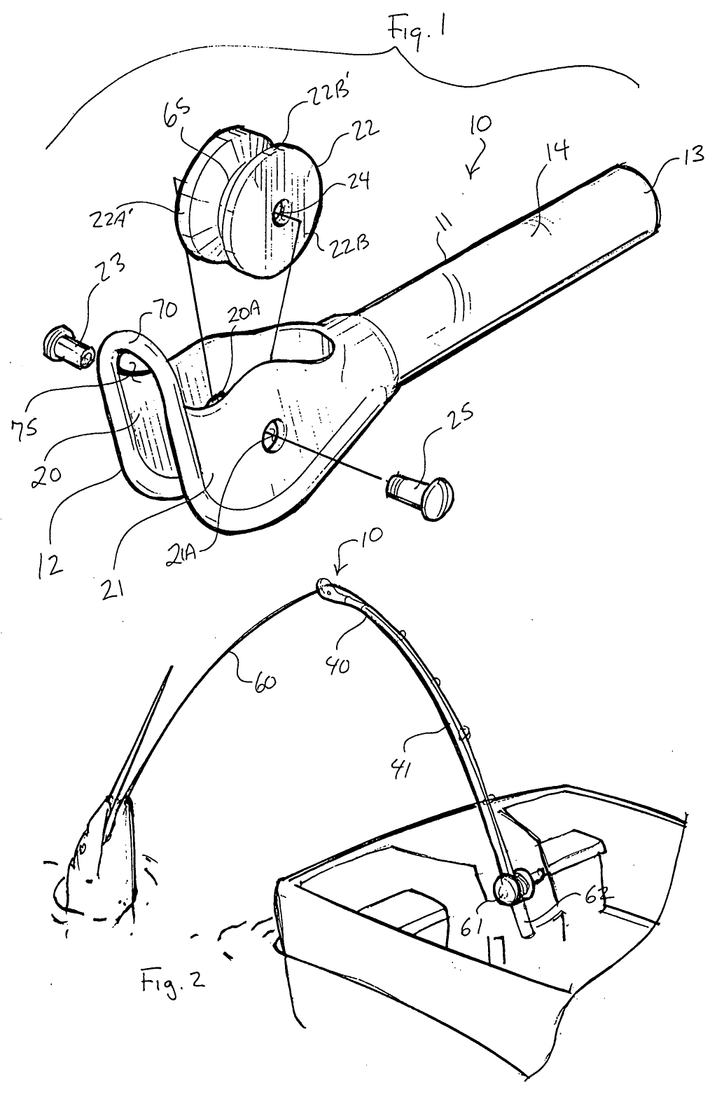

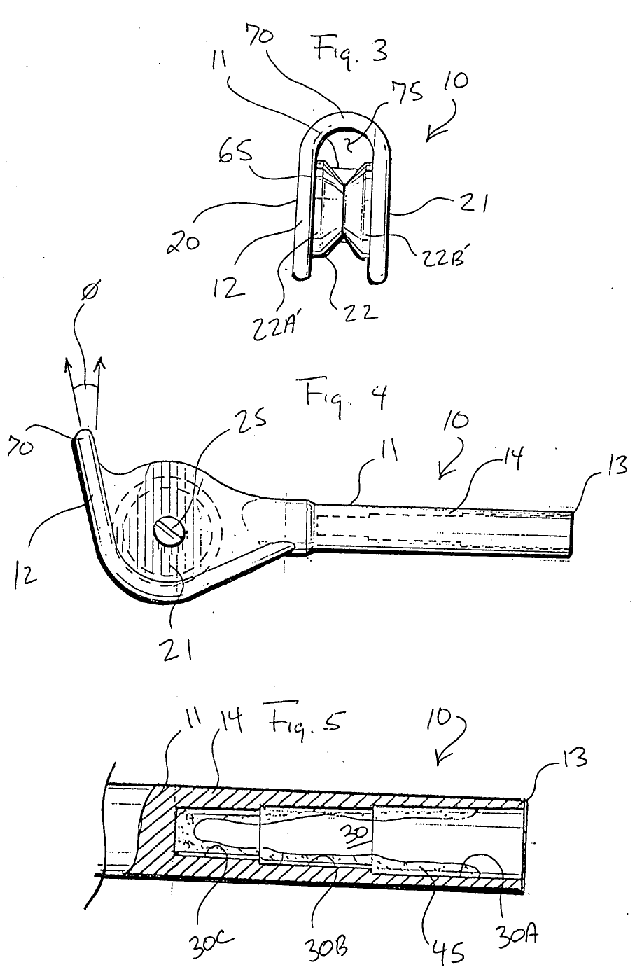

FIG. 2 is illustrative of fishing pole 41 as it would appear in use with roller guide 10 attached thereto guiding a running line 60 from a reel 61 attached at the butt or butt end 62 of fishing pole 41 to the top or tip end 40 of fishing pole 41. It is to be understood that running line 60 runs over roller 22, which, as shown in FIGS. 1 and 3, is formed with central annular groove 65 for guiding running line 60 and maintaining running line 60 with roller 22. Further to FIGS. 1 and 3, an outwardly curved element 70 connects the free ends of branches 20,21, and constitutes a line guard of roller guide 10. It is to be further understood that a running line is passed between roller 22 and element 70, permitting element 70 to inhibit the running line from detaching from roller guide 10. Element 70 is rounded having soft edges, which prevents damage to the running line passing through the space between element 70 and roller 22. This space is denoted at 75 in FIGS. 1 and 3. Space 75 is enlarged as defined by the cooperation between element 70 and roller 22, which provides for increased knot clearance and clearance for line attachments, such as swivels, weights, etc.

Looking back to FIG. 4, curved element 70 is considered the head of roller guide 10. The curved element 70 or head is angled forwardly or outwardly away from roller 22 (not shown in FIG. 4). In other words, the head is angled forwardly of elongate body 11. This forwardly angled character of the head of roller guide 70, which angle is denoted at theta 0 in FIG. 4, is important because it greatly reduces the chance of the fishing line wrapping therearound during “jigging”, and also greatly reduces the chance of the fishing line wrapping around forward end 12 of roller guide 10.

Referring to FIG. 7, illustrated is a vertical sectional view of a roller 100 for use with roller guide 10. In common with roller 22, roller 100 shares sides 22A,22B, annular extremities or flats 22A′,22B′, and groove 65. Unlike roller 22, groove 65 of roller 100 has inwardly angled annular upper surfaces 101A,101B, and inwardly angled annular lower surfaces 102A,102B. Flat 22A′ leads to surface 101A, which leads to surface 102A. Flat 22B′ leads to surface 101B, which leads to surface 102B. The disposition of surfaces 101A,102A, is the mirror image of surfaces 101B,102B, and vice versa. In accordance with the embodiment set forth in FIG. 7, the angles of surfaces 101A,102A are each shallower that the angles of surfaces 102A,102B, respectively. In other words, groove 65 has two angled annular surface regions, namely, the angled annular surface region defined by upper surfaces 101A,101B, and a steeper angled annular surface region defined by lower surfaces 102A,102B, which meet at the reentrant point of groove 65. And so groove 65 in the embodiment designated 100 has opposing inwardly angled annular upper surfaces 101A,101B that lead to opposing inwardly angled annular lower surfaces 102A,102B, in which the angles defined by lower surfaces 102A,102B of roller 100 are steeper than the angles defined by upper surfaces 101A,101B of roller 100. This double angled surface configuration of groove 65 in the embodiment designated 100 prevents a fishing line from catching and getting caught on the flats 22A,22B of roller 100 during use of roller in a roller guide, such as roller guide 10. In a preferred embodiment, surfaces 101A,101B are disposed at 20 degree angles, and surfaces 102A,102B are disposed at 40 degree angles. Other angles for surfaces 101A,101B and surfaces 102A,102B can be used.

Like roller 22, roller 100 is fashioned from stainless steel, aluminum, or other similar material or combination of materials, with stainless steel being preferred for its resilient and non-corrosive properties. Roller 100 is integrally fashioned, but it can be constructed of a plurality of attached parts, whether two or more, if desired.

The present invention is described above with reference to preferred embodiments and preferred teachings. However, those skilled in the art will recognize that changes and modifications may be made to the invention without departing from the nature and scope thereof. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus comprising:
an elongate body having opposing neck and rollered ends; and
a rod end attachment bore formed into the neck end of the elongate body, wherein the attachment bore consists of a series of counterbores extending into the neck end of the elongate body and each defining an inner diameter, in which the inner diameters of the counterbores decrease progressively into the neck end of the elongate body.

2. (Canceled)

3. A fishing pole having a tip disposed in and secured at the attachment bore of the apparatus of claim 1.

4. A fishing pole having a tip disposed in the attachment bore of the apparatus of claim 1 and an adhesive adhesively securing the tip of the fishing pole to the elongate body at the attachment bore.

5. A fishing pole having a tip disposed in the attachment bore of the apparatus of claim 1, a plurality of spaced-apart annular gaps formed between the tip and the attachment bore and an adhesive disposed at the gaps securing the tip to the elongate body at the attachment bore.

6. Apparatus comprising:
an elongate integral body having a proximal end and an opposing rollered distal end having a head angled forwardly of the elongate integral body; and
a rod end attachment bore extending into the elongate integral body from the proximal end toward the rollered distal end, wherein the attachment bore consists of a series of counterbores extending into the elongate integral body from the proximal end of the elongate integral body toward the rollered distal end of the elongate integral body and each defining an inner diameter, in which the inner diameters of the counterbores decrease progressively from the proximal end of the elongate integral body toward the distal end of the elongate integral body.

7. (Canceled)

8. A fishing pole having a tip disposed in and secured at the attachment bore of the apparatus of claim 6.

9. A fishing pole having a tip disposed in the attachment bore of the apparatus of claim 5 and an adhesive adhesively securing the tip of the fishing pole to the elongate integral body at the attachment bore.

10. A fishing pole having a tip disposed in the attachment bore of the apparatus of claim 6, a plurality of spaced-apart annular gaps formed between the tip and the attachment bore and an adhesive disposed at the gaps securing the tip to the elongate integral body at the attachment bore.

11. Apparatus comprising:
a fishing pole having a butt end and an opposing tip end;
an elongate body having opposing neck and rollered ends;
the rollered end including an attached roller having a groove defined by opposing inwardly angled annular upper surfaces that lead to opposing inwardly angled annular lower surfaces, in which the angles defined by the lower surfaces of the roller are steeper than the angles defined by the upper surfaces of the roller;
a rod end attachment bore formed into the neck end of the elongate body, wherein the attachment bore consists of a series of counterbores extending into the neck end of the elongate body and each defining an inner diameter, in which the inner diameters of the counterbores decrease progressively into the neck end of the elongate body;
the tip disposed in the attachment bore; and
an adhesive securing the tip to the elongate body at the attachment bore.

12. (Canceled)

13. Apparatus of claim 11, further comprising:
a plurality of spaced-apart annular gaps formed between the tip and the attachment bore; and
the adhesive disposed at the gaps securing the tip to the elongate body at the attachment bore.

14. Apparatus comprising:
a fishing pole having a butt end and an opposing tip end;
an elongate integral body having a proximal end and an opposing rollered distal end;
a rod end attachment bore extending into the elongate integral body from the proximal end toward the rollered distal end, wherein the attachment bore consists of a series of counterbores extending into the elongate body from the proximal end of the elongate integral body toward the rollered distal end of the elongate integral body and each defining an inner diameter, in which the inner diameters of the counterbores decrease progressively from the proximal end of the elongate integral body toward the distal end of the elongate integral body;
the tip disposed in the attachment bore;
a plurality of spaced-apart annular gaps formed between the tip and the stepped inwardly tapered rod end attachment bore; and
an adhesive disposed at the gaps securing the tip to the elongate integral body at the gaps.

15. (Canceled)

16-23. (Canceled)
